(19) United States
(12) Patent Application Publication
(10) Pub. No.: US 2014/0320420 A1
(43) Pub. Date: Oct. 30, 2014

(54) METHOD AND APPARATUS FOR CONTROLLING A MOBILE DEVICE BASED ON TOUCH OPERATIONS

(71) Applicant: SONY CORPORATION, Minato-ku (JP)

(72) Inventors: Kentaro IDA, Tokyo (JP); Hiromitsu FUJII, Tokyo (JP)

(73) Assignee: SONY CORPORATION, Minato-ku (JP)

(21) Appl. No.: 13/870,454

(22) Filed: Apr. 25, 2013

(51) Int. Cl. G06F 3/041

(52) U.S. Cl. CPC G06F 3/0416
USPC 345/173

(57) ABSTRACT

An apparatus includes circuitry configured to determine, based on an output of a sensor, that an instruction object is within a predetermined distance of a surface of a display. The circuitry may be configured to determine, based the sensor output, a grip pattern corresponding to a position of one or more of a finger and a thumb on a user's hand with respect to the display surface. The circuitry may be configured to execute a predetermined function or process based on the determined grip pattern.

### BACKGROUND

1. Technical Field

The present disclosure relates to a method and apparatus for controlling a mobile device based on detected touch operations.

2. Description of Related Art

Mobile devices may include a touch panel display for performing input operations by contacting an operation surface of the touch panel with an instruction object, such as a finger. Processing circuitry within the mobile device may detect a coordinate on the operation surface corresponding to a detected input operation, and perform further processing based on the detected input operation.

In recent years, in order to make touch panel displays on mobile devices as large as possible, cases framing the mobile device touch panel displays have become increasingly narrow. The narrow mobile device frames allow for increasing the size of the touch panel display without an unnecessary increase in the overall size of the mobile device. Due to the narrow width of the mobile device frames, the likelihood of a user's fingers being inadvertently detected by the touch panel display while the user holds the mobile device is increased, thereby increasing the likelihood that an unintended operation will be performed by the mobile device in response to inadvertent contact with the user's fingers. In light of this problem, a perimeter region surrounding a mobile device touch panel operation surface may be set as an insensitive area that does not receive/detect touch operations, thereby preventing the unintended detection of a user's fingers while the user holds the mobile device. The insensitive area may correspond to an area on the touch panel operation surface adjacent to the mobile device frame. Uniformly setting an insensitive area corresponding to the perimeter of the mobile device touch panel display outer perimeter, while precluding unintended detections of touch operations while the user is holding the mobile device, may have an undesired consequence of preventing the detection of a touch operation performed with respect to an edge of the operating surface of the touch panel display. Under this condition, it therefore becomes impossible to perform an input operation by touching an edge of the touch panel operation surface with an instruction object.

### SUMMARY

Among other things, the present disclosure describes a method and apparatus for controlling a mobile device based on detected inputs on a user interface displayed on a touch panel display. More specifically, the present disclosure describes detecting a touch operation in an area corresponding to an edge of the touch panel and/or a frame of the mobile device, and controlling aspects of the mobile device based on the detected touch operation.

In a certain embodiment, a mobile device may include circuitry configured to determine, based on an output of a sensor, that an instruction object is within a predetermined distance of a surface of a display. The circuitry may be configured to determine, based the sensor output, a grip pattern corresponding to a position of one or more of a finger and a thumb on a user's hand with respect to the display surface. The circuitry may be configured to execute a predetermined function or process based on the determined grip pattern.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary block diagram for a mobile device;

FIG. 2 illustrates an exemplary grip pattern detected on a mobile device touch panel;

FIGS. 3A-3C and 4A-4C illustrate exemplary determinations of grip patterns according to one example;

FIGS. 5A and 5B illustrate algorithmic flowcharts for determining grip patterns according to one example;

FIG. 6 illustrates an edge area on a touch panel according to one example;

FIGS. 7A and 7B illustrate exemplary aspects of controlling a mobile device display according to one example;

FIGS. 8A and 8B illustrate aspects of detecting a touch operation on a mobile device case according to one example;

FIG. 9 illustrates an algorithmic flowchart for detecting a touch operation on a mobile device case according to one example;

FIG. 10 illustrates aspects of determining an incidence angle according to one example;

FIG. 11 illustrates aspects of detecting a touch operation on a mobile device case according to one example;

FIG. 12 illustrates aspects of controlling a display based on a touch operation according to one example;

FIG. 13 illustrates aspects of controlling a display based on virtual key location according to one example; and

FIG. 14 illustrates a non-limiting example of controlling a gaming system according to aspects of the present disclosure.

### DETAILED DESCRIPTION

Referring now to the drawings, wherein like reference numerals designate identical or corresponding parts throughout the several views.

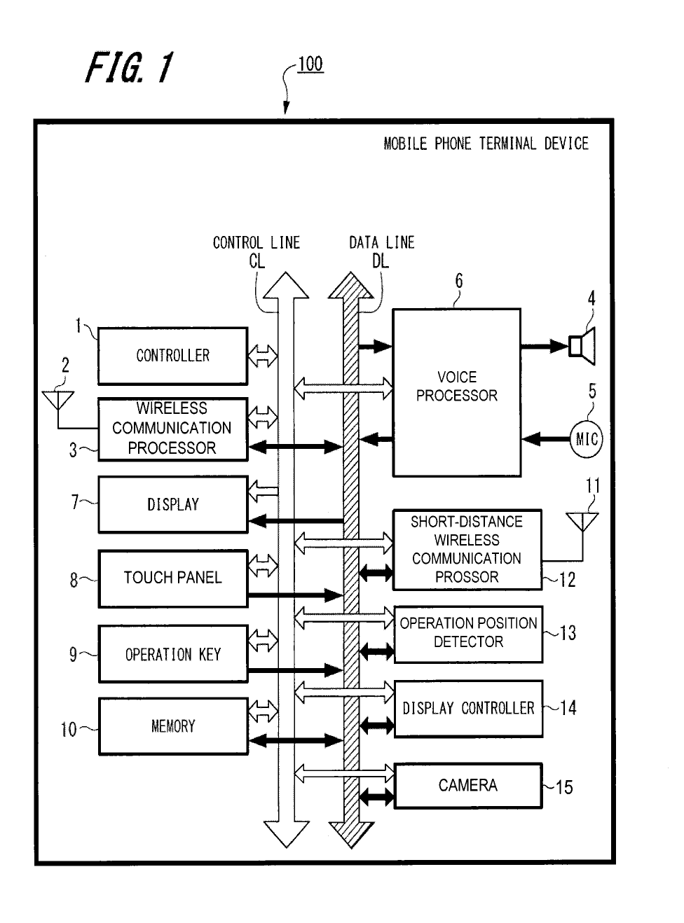

FIG. 1 illustrates a block diagram for an exemplary mobile device 100. The exemplary mobile device 100 of FIG. 1 includes a controller 1, a wireless communication processor 3 connected to an antenna 2, a speaker 4, a microphone 5, and a voice processor 6.

The controller 1 may include one or more Central Processing Units (CPUs), and may control each element in the mobile device 100 to perform features related to communication control, audio signal processing, control for the audio signal processing, image processing and control, and other kinds signal processing. The controller 1 may perform these features by executing instructions stored in a memory 10 or a non-transitory computer readable medium having instructions stored therein. Further, the controller 1 may perform processing related to detecting a touch operation on touch panel 8, as described in further detail in later paragraphs.

The antenna 2 transmits/receives electromagnetic wave signals between base stations for performing radio-based communication, such as the various forms of cellular telephone communication.

The wireless communication processor 3 controls communication performed between the mobile device 100 and other external devices. For example, the wireless communication processor 3 may control communication between the base stations for cellular phone communication.

The speaker 4 emits an audio signal corresponding to audio data supplied from the voice processor 6.

The microphone 5 detects surrounding audio, and converts the detected audio into an audio signal. The audio signal may then be output to the voice processor 6 for further processing.

The voice processor 6 demodulates and/or decodes the audio data read from the memory 10, or audio data received by the wireless communication processor 3 and/or a short-distance wireless communication processor 12. Additionally, the voice processor 6 may decode audio signals obtained by the microphone 5.

The display 7 may be a Liquid Crystal Display (LCD), or another known display screen technology. In addition to displaying images, the display 7 may display operational inputs, such as numbers or icons, which may be used for control of the mobile device 100.

Touch panel 8 may include one or more touch sensors for detecting a touch operation on an operation surface of the touch panel. In certain aspects of the present disclosure, the touch panel 8 may be disposed adjacent to the display 7, or may be formed integrally with the display 7. For simplicity, the present disclosure assumes the touch panel 8 is a capacitance-type touch panel technology; however, it should be appreciated that aspects of the present disclosure may easily be applied to other touch panel types, such as resistance, infrared grid, optical, or the like. In certain aspects of the present disclosure, the touch panel 8 may include transparent electrode touch sensors arranged in the X-Y direction on the surface of transparent sensor glass.

A touch panel driver may be included in the touch panel 8 for control processing related to the touch panel 8, such as scanning control. For example, the touch panel driver may scan each sensor in a transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel 8. Additionally, the touch panel driver and touch panel 8 may detect when an instruction object, such as a finger, is within a predetermined distance from an operation surface of the touch panel 8. That is, the instruction object does not necessarily need to directly contact the operation surface of the touch panel 8 for touch sensors to detect the instruction object and perform processing described herein.

The display 7 and the touch panel 8 may be encompassed by a frame portion of a protective case on the mobile device 100. The frame portion of the case may be substantially narrow (e.g., 1-3 mm) such that the overall size of the mobile device 100 is minimized.

The operation key 9 may include one or more buttons or similar external control elements, which may generate an operation signal based on a detected input by the user. These operation signals may be supplied to the controller 1 for performing related processing and control. As discussed later, some or all of the aspects of the operation key 9 may be integrated into the touch panel 8 and the display 7 as “virtual” keys.

The memory 10 may include, e.g., Read Only Memory (ROM), Random Access Memory (RAM), or a memory array comprised of a combination of volatile and non-volatile memory units. The memory 10 may be utilized as working memory by the controller 1 while executing the processing and algorithms of the present disclosure. Additionally, the memory 10 may be used for long-term storage, e.g., of images and information related thereto.

The antenna 11 may transmit/receive electromagnetic wave signals to/from other external apparatuses, and the short-distance wireless communication processor 12 may control the wireless communication performed between the other external apparatuses. Bluetooth, Wi-Fi, and near-field communication are non-limiting examples of wireless communication protocols that may be used for inter-device communication by the short-distance wireless communication processor 12.

Operation position detector 13 may detect a position of an instruction object, such as a finger, with respect to an operation surface of the touch panel 8 and/or a surface of a case (or frame portion of the case) on the mobile device 100. In certain aspects of the present disclosure, the operation position detector 13 determines a position of the instruction object by determining an electrostatic capacitance value and corresponding coordinate on the touch panel 8 and/or an edge of the touch panel 8 corresponding to a touch operation on the mobile device 100 case. For example, the operation position detector 13 may determine a coordinate on the touch panel 8 corresponding to an edge of the touch panel closest to a position on the mobile device 100 case at which a touch operation is performed/detected.

Display controller 14 may control the display 7 in response to a touch operation. For example, the display controller 14 may change the position of an icon or other interface element displayed on the display 7 based on the position of a user's finger detected by the operation position detector 13. In another aspect of the present disclosure, the display controller 14 may determine boundaries of an insensitive area on the touch panel 8. The insensitive area may correspond to an area of the touch panel 8 at which touch operations are not registered by the mobile device 100 (i.e., while touch sensors may detect the touch operation, the controller 1 and other mobile device 100 elements do not respond to the touch operation).

Images may be captured by the mobile device 100 via the camera 15, which may include an image sensor comprised of a Charge Coupled Device (CCD), Complementary Metal Oxide Semiconductor (CMOS), or the like. For example, an image signal may be generated by the camera 15 when an image formed on a light-receiving surface through a lens is photoelectrically converted. The lens of the camera 15 may, e.g., be arranged on a back surface of the mobile device 100 (i.e., opposite the display 7). The camera 15 may be comprised of one or more image processors. The image processors may execute instructions stored in the memory 10 for analyzing aspects of images captured by the camera 15. In certain aspects of the present disclosure, the image processors may detect facial features captured in an image.

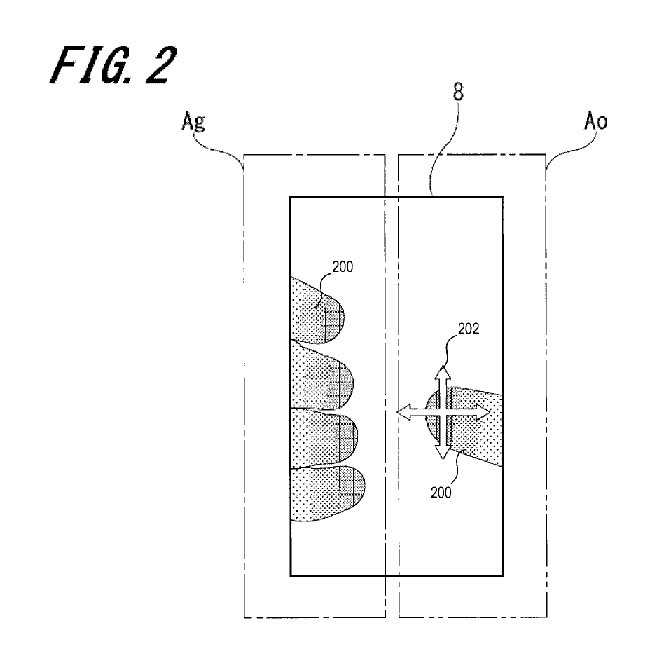

Next, FIG. 2 illustrates a non-limiting example of detecting a grip pattern on a mobile device touch panel according to one aspect of the present disclosure. Grip pattern 200 illustrated in FIG. 2 represents an exemplary electrostatic capacitance distribution pattern detected by a touch sensor included in the touch panel 8. For illustration purposes, varying magnitudes of electrostatic capacitance are illustrated in the figure using different shading patterns. Detected electrostatic capacitance measurements may vary, for example, due to the varied proximity of a user's fingers with respect to the touch panel 8. In this example, four substantially partial ellipse shaped electrostatic capacitance distributions are detected by the touch sensor on the touch panel 8 on the left-hand portion of the touch panel 8 display, and a single partial ellipse shaped electrostatic capacitance distribution is detected on the right-hand portion of the touch panel 8. Such an electrostatic capacitance distribution pattern may result, for example, from a user holding the mobile device in his or her right hand and performing input touch operations using their thumb. The arrows 202 shown in the right-hand portion of the touch panel 8 display are merely provided in this figure to illustrate touch operations being performed with the thumb, and are typically not displayed on the mobile device display or detected as part of a grip pattern detection.

In response to detecting two or more partial ellipses grip patterns on a portion of the operating surface of the touch panel 8, the controller 1 may set a boundary area on the touch panel 8 corresponding to side area Ag. The controller 1 may determine that the side area Ag corresponds to an area of the touch panel 8 in which a user is gripping the frame of the mobile device with his or her fingers. Used hereinafter, the term “fingers” corresponds to the four non-thumb fingers on a user's hand. Similar to the example for the side area Ag, the controller may determine that the side area Ao corresponds to an area of the touch panel 8 in which the user's thumb grips the case of the mobile device 100. The boundaries of the side area Ao may be set by the controller 1 by detecting a predetermined electrostatic capacitance distribution pattern corresponding to a single partial ellipse-shaped distribution. It is noted that while partial ellipse patterns are described herein as corresponding to typical touch panel sensor outputs resultant from gripping a mobile device with a hand, other predetermined pattern shapes may be associated with gripping the mobile device with a hand, based on the nature of the sensors.

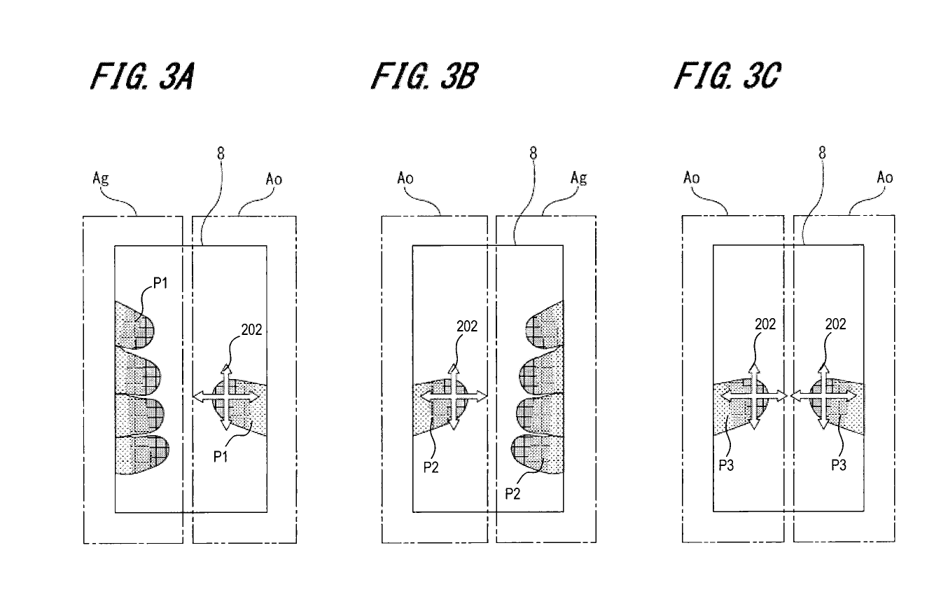

Next, FIGS. 3A-3C illustrate non-limiting examples of grip patterns that may be detected by the touch panel 8. Referring first to FIG. 3A, a grip pattern P1 may be detected by the touch panel 8 in response to a user gripping the mobile device 100 with his or her right hand and performing input operations using his or her right thumb. As discussed above, the controller 1 may set the side area Ag to correspond to an area in which an electrostatic capacitance distribution results in two or more partial ellipse-shaped distribution patterns, such as the portion of pattern P1 shown in the left-hand portion of the touch panel 8 of FIG. 3A. Similarly, the controller 1 may set the side area Ao to correspond to an area in which an electrostatic capacitance distribution includes only a single partial ellipse-shaped pattern.

FIG. 3B illustrates an exemplary grip pattern P2, which may correspond to a user gripping the mobile device 100 with his or her left hand and performing input operations with his or her left thumb. The side areas Ag and Ao may be determined similarly to the example discussed above for FIG. 3A.

FIG. 3C illustrates an exemplary grip pattern P3, which may correspond to a user gripping the mobile device 100 with both hands on the longer sides (i.e., right and left sides) of a rectangular mobile device, and performing input operations with his or her left and right thumbs. In this case, only a single partial ellipse electrostatic capacitance distribution pattern is detected on the left and right sides of the touch panel 8. Accordingly, the controller 1 may set both the left- and right-hand sides of the touch panel 8 as having boundaries corresponding to the side areas Ao shown in the figure.

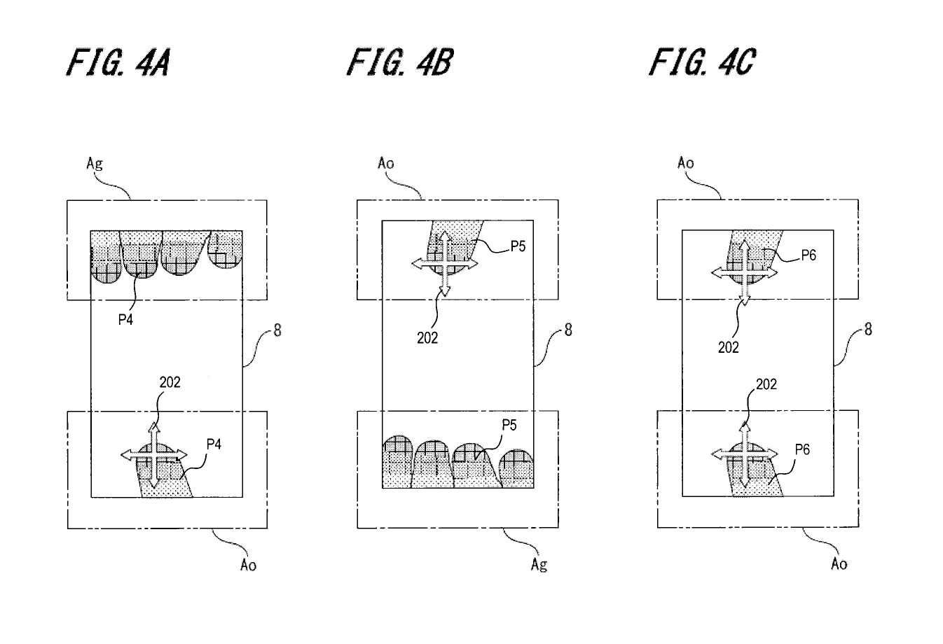

Next, FIGS. 4A-4C illustrates exemplary grip patterns detected as a user grips the mobile device 100 on the shorter (i.e., upper and lower) sides of the rectangular mobile device. Referring first to FIG. 4A, an exemplary grip pattern P4 is shown, which may correspond to a user gripping the mobile device 100 with his or her left hand and performing input operations using his or her left thumb. The controller 1 may set boundaries corresponding to the side areas Ag and Ao as discussed above for FIGS. 3A-3C.

FIG. 4B illustrates an exemplary grip pattern P5, which corresponds to a user gripping the mobile device 100 with his or her right hand and performing input operations using his or her right thumb. Again, the controller 1 may set boundaries corresponding to the side areas Ag and Ao as discussed in the foregoing examples.

FIG. 4C illustrates an exemplary grip pattern P6, which may correspond to a user gripping the mobile device 100 with two hands on the upper and lower sides of the rectangular mobile device. As in the case of FIG. 3C, the controller 1 may determine that only single partial ellipse-shaped electrostatic capacitance pattern is detected on the upper and lower sides of the mobile device 100, and accordingly set boundaries corresponding to side areas Ao for both the upper and lower sides of the mobile device touch panel 8.

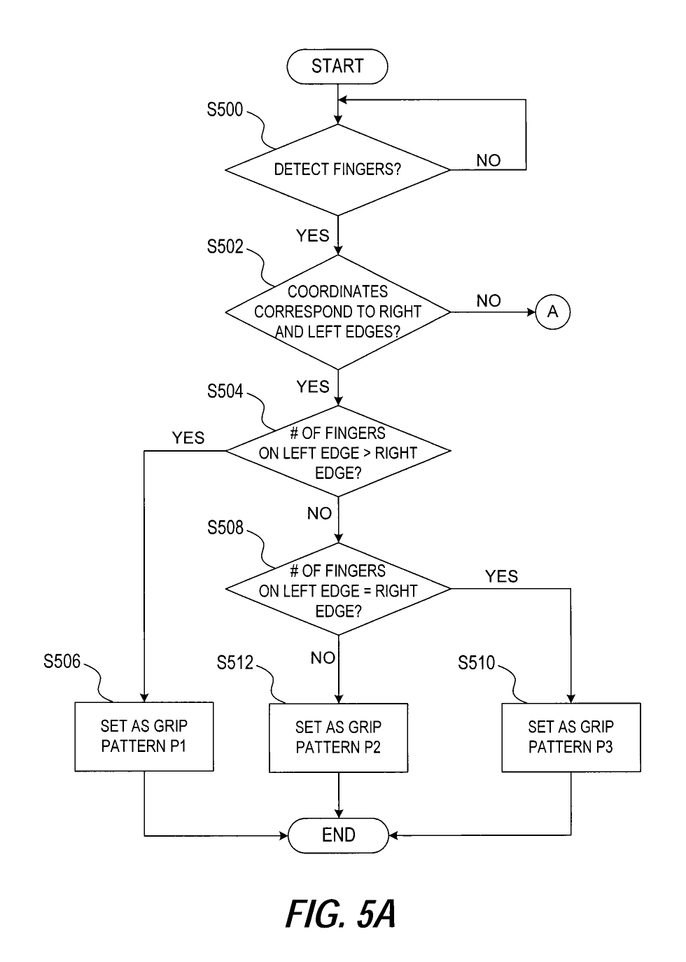

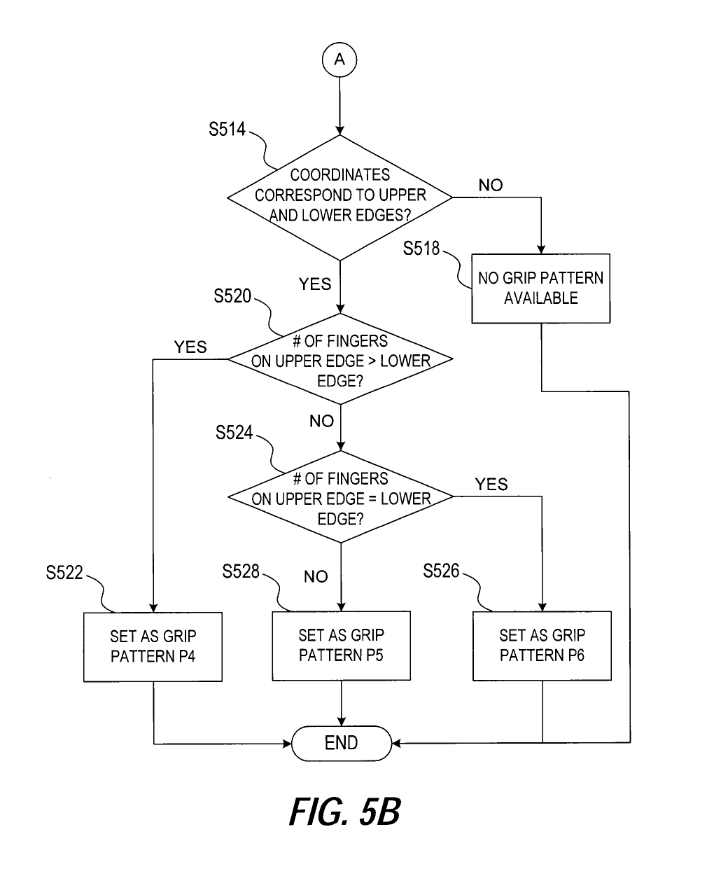

Next, FIGS. 5A and 5B illustrate exemplary algorithmic flowcharts for detecting a grip pattern on a mobile device. Referring first to FIG. 5A, the controller 1 at step S500 determines whether one or more fingers are detected within a predetermined distance from an operation surface of the touch panel 8. If a detection is made at step S500, the operation position detector 13 determines at step S502 whether the coordinates of the detected fingers correspond to a right and/or left edge of the operation surface of the touch panel 8. If the operation position detector 13 determines that the detected coordinates correspond to the left and/or right edges of the operation surface of the touch panel 8 at step S502, the operation position detector 13 determines at step S504 whether a number of fingers detected on the left edge of the touch panel 8 operation surface is greater than the number of fingers detected on the right edge of the operation surface of the touch panel 8. An affirmative determination at step S504 may, for example, correspond to a user holding the mobile device with his or her right hand. If the operation position detector 13 determines at step S504 that there are a greater number of detected fingers on the left edge than the right edge of the operation surface of the touch panel 8, the controller 1 at step S506 sets the determined grip pattern as pattern P1. Otherwise, the operation position detector 13 at step S508 determines whether the number of detected fingers on the left edge of the operation surface of the touch panel 8 equals the number of detected fingers on the right edge of the operation surface of the touch panel 8. If so, the controller 1 at step S510 sets the determined grip pattern to pattern P3. Otherwise, the controller 1 at step S512 sets the determined grip pattern as pattern P2.

Referring now to FIG. 5B, if the operation position detector 13 determines that the coordinates of the detected fingers do not correspond to left and/or right edges of an operation surface of the touch panel 8 at step S502, the detection at step S500 may have been the result of a user gripping the mobile device 100 at its upper and lower regions (i.e., the user grips the rectangular mobile device longways using a one or both hands). Accordingly, the operation position detector 13 at step S514 determines whether the coordinates of the detected fingers correspond to upper and/or lower edges of the operation surface of the touch panel 8. If a determination is made at step S514 that the detected coordinates do not correspond to an upper or lower edge of the mobile device 100, the controller 1 at step S518 determines that no grip pattern is available (e.g., the grip pattern is undetermined and/or the mobile device is not being held). Otherwise, the operation position detector 13 at step S520 determines if the number of detected fingers on the upper edge of the operation surface of the touch panel 8 is greater than the number of detected fingers at the lower edge of the operation surface of the touch panel 8. If so, the controller 1 at step S522 determines that a grip pattern P4 should be set. Otherwise, the operation position detector 13 at step S524 determines whether the number of detected fingers on the upper edge is equal to the number of detected fingers of the lower edge of the operation surface of the touch panel 8. If so, the controller 1 at step S526 sets the determined grip pattern as pattern P6. Otherwise, the controller 1 at step S528 sets the determined grip pattern as pattern P5.

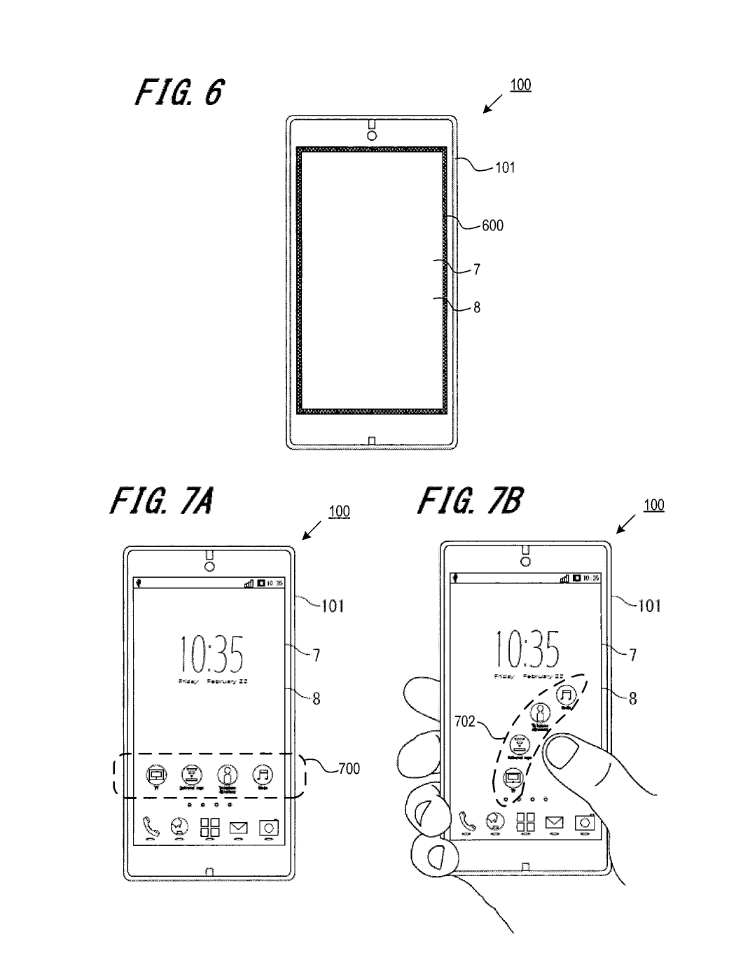

Next, FIG. 6 provides an exemplary illustration of an edge area of an operation surface of a mobile device touch panel. In this example, an “edge” of a touch panel operation surface may correspond to the hashed edge 600 area shown in FIG. 6. In a non-limiting example, the operation position detector 13 may determine whether a touch operation corresponding to an electrostatic capacitance distribution pattern is detected within or within a predetermined distance of the boundaries of the area defined by the edge 600 by determining whether the X and/or Y coordinates of the detected touch operation are zero or at the maximum value. That is, the operation position detector 13 may determine whether a touch operation is performed at or near the edge 600 by determining whether the coordinates of the touch operation correspond to the extremis X-Y coordinates of the display 7 and/or the touch panel 8.

Next, FIGS. 7A and 7B provide a non-limiting example illustrating aspects of controlling a user interface based on a detected touch operation. Referring first to FIG. 7A, FIG. 7A illustrates a case in which the mobile device 100 is not being held by a user's hand. A user interface is displayed on the display 7. The exemplary user interface includes four icons displayed within an area 700. The four icons displayed within the area 700 in this example are shown as being arranged in a substantially horizontal row near a bottom portion of the display 7.

FIG. 7B illustrates a case in which the controller 1 and/or the display controller 14 controls the user interface displayed on the display 7 such that the four icons previously shown arranged horizontally in the area 700 are now arranged in a fanned pattern shown in area 702. As shown in FIG. 7B, in response to a determination that a user's thumb is detected at or near a predetermined location by the touch panel 8, the controller 1 may control the user interface such that the icons shown in the area 702 are rearranged on the display 7 such that they are within a predetermined distance from a detected coordinate corresponding to the user's thumb. The predetermined distance at which the icons in the area 702 are arranged is preferably set such that the icons are within easy reach of the user's thumb, thereby improving user friendliness. In this example, the controller 1 may determine that a grip pattern P1 should be set based on a detected electrostatic capacitance pattern using methods described herein. In response to the grip pattern determination, the controller 1 may then control the user interface displayed on the display 7 such that the icons in the area 702 are fanned in a right-hand portion of the display 7, such that the user may perform input operations of the icons using his or her thumb.

It should be appreciated that the shape shown in the example of FIG. 7B with respect to the icons of the area 702 is not limiting, and aspects of the present disclosure may easily be adapted such that the controller 1 controls the user interface displayed on the display 7 such that the icons are arranged in other shapes in which a user may easily reach the icons using his or her thumb (or another finger) based on the detected grip pattern. For example, the interface may be controlled such that the icons encircle the coordinate corresponding to the user's thumb. Additionally, aspects of controlling the user interface are not limited to controlling a location of icons displayed on the user interface based on the detected grip pattern. For example, a scroll bar for moving content displayed on the display 7 upwards or downwards may be arranged on a side of the display 7 in response to detecting a predetermined grip pattern such that the user may easily scroll the content upwards or downwards using his or her thumb. Further, the present disclosure is not limited by a detection of a grip pattern solely on an operation surface of the touch panel 8. That is, while the example of FIG. 7B may illustrate the thumb in a proximity of the operation surface of the touch panel 8, aspects of the present disclosure may be adapted such that the controller 1 controls the user interface based on a determined grip pattern in which the user is gripping the phone only on the case 101. In other words, electrostatic capacitance may still be detected when a user is gripping the case 101 while not actually contacting the operation surface of the touch panel 8 with his or her fingers. Detecting an electrostatic capacitance of a user's finger when the user has not actually contacted the touch panel 8 is a result of narrow widths of the case 101 typically seen in modern mobile devices. Moreover, sensitivity of the touch sensors included in the touch panel 8 may be adjusted such that an electrostatic capacitance of an instruction object such as a user's finger is detected at a greater proximity, as well as determining edge coordinates of the touch panel 8 corresponding to the grip on the case 101.

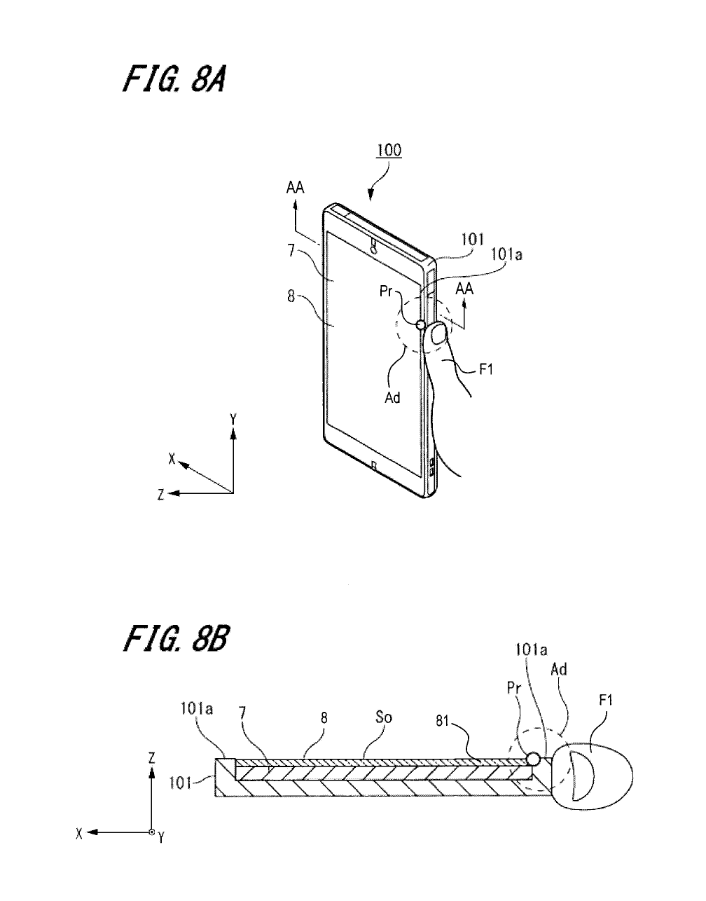

Next, FIGS. 8A and 8B illustrate exemplary aspects of detecting a touch operation on a side surface of a mobile device case. FIG. 8A illustrates the mobile device 100 from a front diagonal perspective, and FIG. 8B illustrates the mobile device 100 of FIG. 8A as a cross-sectional view corresponding to the line AA shown in FIG. 8A. Referring to FIG. 8B, a touch sensor 81 is shown stacked on top of a top surface of the display 7. In certain aspects of the present disclosure, the touch sensor 81 may be formed integrally with the touch panel 8 and/or the display 7. The touch sensor 81 may include one or more sensors for detecting a touch operation on the touch panel 8. In one aspect of the present disclosure, the touch sensor 81 detects a touch operation on the touch panel 8 via electrostatic capacitance measurements between an instruction object, such as a user's finger, and the touch sensor 81 sensors. Further, in certain aspects of the present disclosure, the touch sensor 81 may comprise a plurality of transparent electrode sensors arranged in an X-Y direction on a panel surface of transparent sensor glass. As shown in FIGS. 8A and 8B, a frame portion 101a of the case 101 is relatively narrow in width, resulting in electrostatic capacitance values being detectable by the touch sensor 81 when a finger F1 is in contact with the frame portion 101a (even if not directly contacting an operation surface So of the touch panel 8). In particular, when the finger F1 is in contact with the frame portion 101a, an electrostatic capacitance measurement may be detected within at least an area Ad, with a maximum magnitude of electrostatic capacitance measurement being detected at an edge of the touch panel 8 that is adjacent to the frame portion 101a with which the finger F1 is in contact. The point of maximum electrostatic capacitance measurement on the edge of the operation surface So is represented herein as detection point Pr. It should be appreciated that because an influence of an electrostatic capacitance may be measured within the area Ad, it is not necessary for the finger F1 to come in contact with the frame portion 101a in order for an electrostatic capacitance measurement to be detected. Accordingly, a detection when the finger F1 is in the proximity of the frame portion 101a (e.g., within the radius of the area Ad) may, in certain aspects of the present disclosure, trigger aspects of mobile device processing set forth herein.

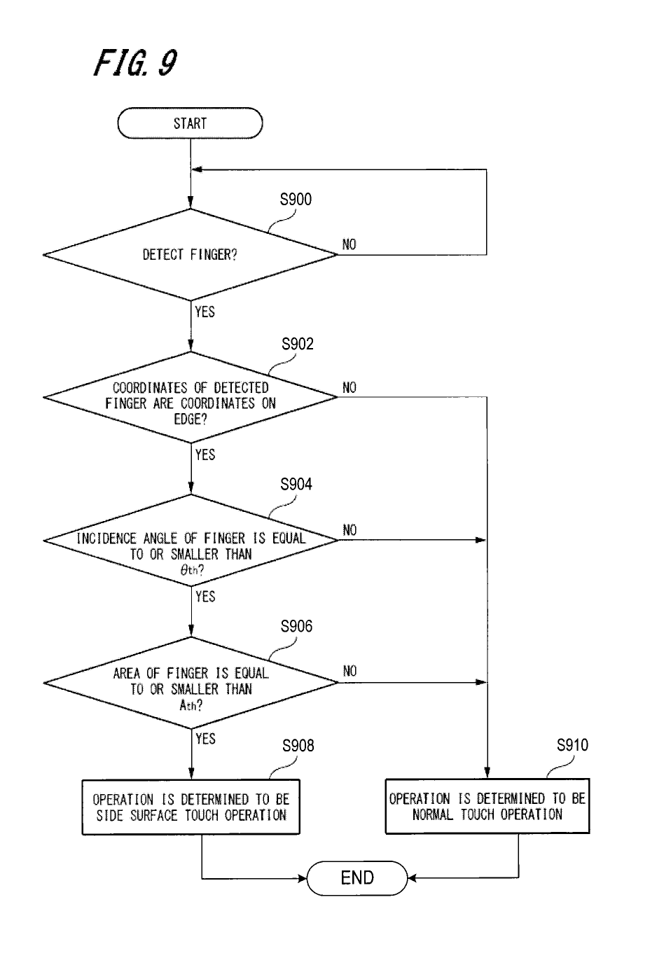

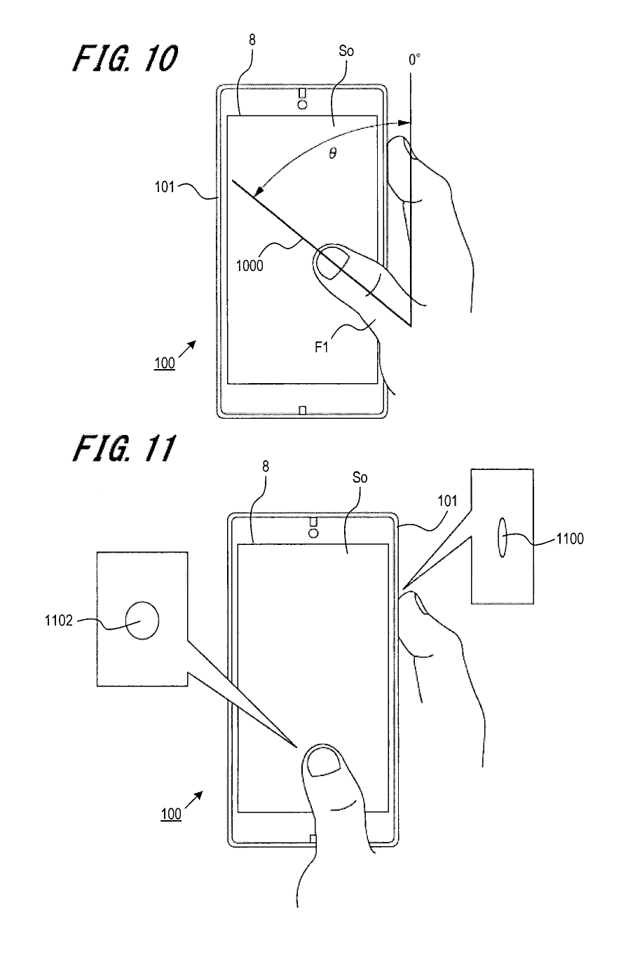

Next, FIG. 9 illustrates exemplary algorithmic flowchart for detecting a touch operation on a side surface of a mobile device case in one aspect of the present disclosure. At step S900, the controller 1 determines if a touch operation is detected by the touch sensor 81. The detection at step S900 may, in certain aspects of the present disclosure, include a determination of whether an electrostatic capacitance measurement magnitude is above a predetermined threshold. At step S902, the operation position detector 13 determines if the coordinates of the detected touch operation correspond to coordinates of an edge of the operation surface So on the touch panel 8. If the operation position detector 13 determines that the coordinates corresponding to the detected touch operation do not correspond to coordinates on the edge of the touch panel 8, the controller 1 determines that a normal touch operation has been performed at step S910 (i.e., the user is touching the operation surface So). Otherwise, at step S904 the operation position detector 13 determines whether an incidence angle (discussed in further detail with respect to FIG. 10) of the detected finger with respect to the operation surface So of the touch panel 8 is below a predetermined angle θth. The incidence angle may, in certain aspects of the present disclosure, correspond to an inclination angle of the detected finger to the right and/or left side (or the upper and/or lower side) of the operation surface So of the touch panel 8. When the operation position detector 13 determines that the incidence angle of the detected finger is greater than the angle θth, the operation position detector 13 determines at step S910 that a normal touch operation has been performed. Otherwise, the operation position detector 13 at step S906 determines if an area corresponding to the detected touch operation on the touch panel 8 is less than or equal to a predetermined area threshold Ath. The detected area may, in certain aspects of the present disclosure, represent an area of an electrostatic capacitance detection pattern. If the detected area of the touch operation is greater than the predetermined area Ath at step S906, the controller 1 at step S910 determines that a normal touch operation has been performed. Otherwise, the controller at step S908 determines that a touch operation on a side surface of the mobile device 100 case 101 has been performed.

Next, FIG. 10 illustrates a non-limiting example of determining an incidence angle in one aspect of the present disclosure. In certain aspects of the present disclosure, the example shown in FIG. 10 may correspond to the determination performed at step S904 of FIG. 9. As noted above, the incidence angle may represent an angle formed relative to the right/left and/or upper/lower sides of the mobile device 100. In the example shown in FIG. 10, the incidence angle θ is measured with respect to a right side of the mobile device 100. Accordingly, an incidence angle of a detected finger relative to the 0-degree angle defined by the right side of the mobile device 100 may be calculated as the incidence angle θ. The incidence angle θ may be calculated using geometric relationships based on the detected position of the finger. For example, the incidence angle θ of a detected finger may be calculable based on a length and/or orientation of the detected electrostatic capacitance distribution pattern. That is, an electrostatic capacitance detection pattern corresponding to a touch operation of finger F1 on the operation surface So of the touch panel 8 may form a substantially elliptical shape, with the major diameter of the ellipse corresponding to axis 1000 shown in FIG. 10. Accordingly, the incidence angle θ may be calculated based on the angular difference between the estimated incident axis 1000 and the O-angle reference formed by the right hand side of the mobile device 100.

Next, FIG. 11 provides a non-limiting example of determining an area of a detected distribution pattern corresponding to a touch operation. In certain aspects of the present disclosure, the example shown in FIG. 11 may correspond to the determination performed at step S906 of FIG. 9. Referring to FIG. 11, edge area 1100 and surface area 1102 correspond to an electrostatic capacitance distribution on the case 101 and the operation surface So of the touch panel 8, respectively. That is, when a finger contacts the operation surface So of the touch panel 8, an electrostatic capacitance pattern is detected and a distribution area of the electrostatic capacitance pattern is distributed throughout a substantially elliptical shaped area having a minor diameter corresponding substantially to the diameter of the finger in contact with the touch panel 8. On the other hand, when a finger is in contact with a side surface of the case 101 as in the example shown in FIG. 11, an electrostatic capacitance is detected and the distribution of the measured electrostatic capacitance values form a substantially elliptical shape, but the distribution pattern typically has a minor diameter that is shorter than the user's finger width. Consequently, when a finger contacts a side surface of the case 101, the distribution area of the detected electrostatic capacitance values becomes smaller than the case in which the operation surface So is touched, as exemplified by the relative size differences between the edge area 1100 and the surface area 1102 shown in FIG. 11. In certain aspects of the present disclosure, a diameter of an ellipse-shaped electrostatic capacitance distribution may be measured and the controller 1 may determine a touch operation is performed on the case 101 when the measured ellipse diameter is below a predetermined threshold diameter length. In other aspects of the present disclosure, the longer (major) diameter of the detected electrostatic capacitance distribution ellipse may be measured and compared to a shorter (minor) diameter of the electrostatic capacitance distribution ellipse, and when the ratio between the longer diameter and the shorter diameter is above a predetermined ratio, a determination may be made that the touch operation corresponds to a finger touching a side surface of the case 101. Moreover, in further aspects of the present disclosure, when a user's finger performs a touch operation on a side surface of the case 101, the maximum magnitude of the electrostatic capacitance value detected by the touch sensor 81 of the touch panel 8 is typically smaller relative to the case in which a touch operation is performed on the operation surface So. For this reason, the magnitude of the maximum detected electrostatic capacitance value may be considered when determining whether a finger is in contact with the case 101 or the operation surface So. A determination of the maximum detected electrostatic capacitance value may be considered independently, such as a comparison to a predetermined threshold electrostatic capacitance value, or in combination with the methods described above.

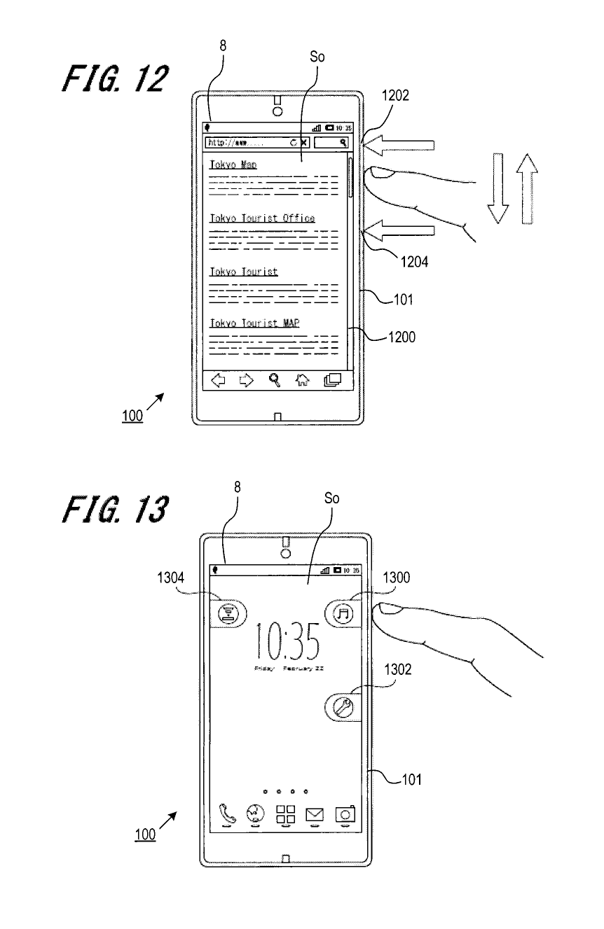

Next, FIG. 12 illustrates a non-limiting example of controlling aspects of a user interface based on a touch operation detected on a side surface of a mobile device case. In this example, an interface displaying Internet search results on the display 7 may be scrolled upwards or downwards based on detected touch operations. For example, the operation position detector 13 may detect a “slide” operation corresponding to a finger sliding upwards or downwards on the case 101. The slide operation may, for example, be determined by temporal changes in measured electrostatic capacitance magnitudes and/or coordinates. In response to detecting the slide operation, the displayed interface may be scrolled upwards or downwards via scrollbar 1200. Similarly, the controller 1 may control the interface to “jump” or scroll to a predetermined scrollbar location based on a detected touch operation on the case 101. In this case, the position on the scrollbar that the interface jumps or scrolls to may correspond to the position the user touches on the case 101. For example, the scrollbar may jump/scroll to a position corresponding to point 1202 on the case 101 in response to the user touching the point 1202. As discussed previously, the position on the display 7 at which the scrollbar is displayed may also be determined based on the detected grip pattern. For example, the controller 1 may control the display 7 such that the scrollbar is displayed near a user's thumb, based on the detected grip pattern.

As another non-limiting example, volume control operations may be executed for the mobile device 100 in response to a detection of a touch operation on the case 101. For example, a touch operation may be detected at the position 1202 shown in FIG. 12 using methods set forth herein. In response to the touch operation being detected at the position 1202, the controller 1 may increase the mobile device 100 volume output from the speaker 4. Conversely, when a touch operation is detected at a position 1204 using methods set forth herein, the controller 1 may decrease the volume output by the speaker 4. The controller 1 may also increase the volume output from the speaker 4 in response to detecting a slide operation upwards on the case 101. Conversely, the controller 1 may decrease the volume output from the speaker 4 in response to detecting a slide operation of a finger downwards on the case 101.

As another non-limiting example, the mobile device 100 may interface with external devices, such as a television set, and control processing for the external device may be executed in response to a detected touch operation. In the exemplary case of a television set being controlled by the mobile device 100, the channel may be changed upwards and downwards when touch operations similarly to the above-described volume control example. Control of external devices such as television sets may, for example, be executed via the controller 1 and the short-distance wireless communication processor 12 and the antenna 11.

In other aspects of the present disclosure, external operational keys typically included in the operation key 9 may be replaced with virtual keys for performing corresponding operations. For example, many mobile devices typically include volume control keys on an external surface of the mobile device. Thus, the operational volume control keys, power control keys, etc. may be replaced by virtual keys via detection of touch operations using methods described herein. Replacing physical keys, buttons, etc. with virtual keys arranged on at least a side surface of the case 101 provides a benefit of improved waterproof functionality of the mobile device 100.

Next, FIG. 13 illustrates further exemplary aspects of controlling a mobile device display based on a detected touch operation on the mobile device case 101. Referring to FIG. 13, the mobile device 100 displays icons 1300, 1302, and 1304, which may control functional aspects of the mobile device 100 via the controller 1. The icons 1300 through 1304 may, in certain embodiments, be displayed in locations on the display 7 corresponding to predetermined virtual keys assigned to locations on a side surface of the case 101. That is, the controller 1 and/or the operation position detector 13 may determine that a touch operation performed at predetermined locations on the side surface of the case 101 corresponds to an input operation for the corresponding displayed icons 1300-1304. In certain aspects of the present disclosure, a user may configure the location at which the icons are displayed on the mobile device 100 display 7, as well as controlling the corresponding locations of virtual keys used for detecting inputs for the icons on the case 101.

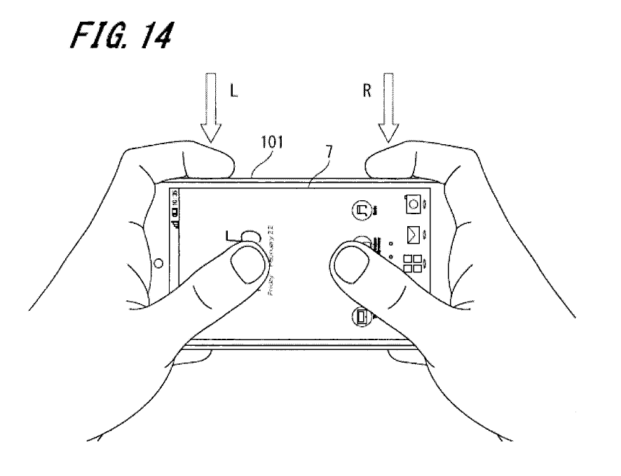

Next, in certain aspects of the present disclosure, the mobile device 100 may execute processing such that control of a gaming system is executed locally or externally via a communication interface, such as the short distance wireless communication processor 12. FIG. 14 illustrates a non-limiting example of incorporating aspects of the present disclosure for controlling a game system. FIG. 14 illustrates an example in which a user is holding a mobile device at its upper and lower sides (i.e., grip pattern P6). In this example, predetermined functionality may be assigned to virtual keys on the case 101, in which case control functionality for the gaming system may be performed by detecting a touch operation corresponding to the virtual key location. For example, the example shown in FIG. 14 illustrates virtual keys corresponding to “L” and “R” buttons commonly included on gaming system controllers. The mobile device controller may execute predetermined functionality in response to detecting a touch operation on the case 101 at a position corresponding to the L and/or R buttons. In this way, the user can easily operate the gaming system using not only his or her thumbs in contact with the display 7, but also the index fingers gripping the case 101, thereby providing greater functionality for control of the gaming system. It should be appreciated that the gaming system controlled in this example may include an external gaming system, in which case control signals may be sent by communication processors such as the short-distance wireless communication processor 12. Further, computerized games may also be executed on the mobile device 100 itself, in which case the user is able to perform input operations using both the operation surface of the touch panel 8 and virtual keys at predetermined locations on the case 101.

Next, in certain aspects of the present disclosure, insensitive areas may be assigned to prevent device malfunction due to unintended touch operations performed by a user's fingers while gripping a mobile device. For example, in response to detecting grip patterns corresponding to patterns P1 and P2 shown in FIGS. 3A and 3B and patterns P4 and P5 shown in FIGS. 4A and 4B, the controller 1 may determine that an insensitive area should be set with boundaries determined based on the detection of the grip pattern. In particular, the controller 1 may establish insensitive area boundaries such that a touch operation performed with the user's fingers gripping the mobile device on a side opposing the user's thumb are precluded from performing touch operations. For example, the controller 1 may establish insensitive area boundaries on the touch panel 8 corresponding to the area Ag overlapping the touch panel 8 in FIGS. 3A and 3B. Insensitive area boundaries may be determined by the controller 1 based on a desired sensitivity for detecting and preventing unintended touch operations. For example, the controller 1 may establish an insensitive area boundary on all or a portion of a side of the touch panel 8. Further, the controller 1 may establish an insensitive area boundary corresponding to an edge of a grip pattern detected within the touch panel 8, such as a position on the touch panel 8 corresponding to the last electrostatic capacitance value detected within the grip pattern above a predetermined value (e.g., the detection of a fingertip).

In other aspects of the present disclosure, a detection of a face (e.g., from a captured image) may be utilized and considered when executing processing described herein. For example, the controller 1 may execute functional aspects of the mobile device 100 in response to detecting a grip pattern/touch operation by methods set forth herein, as well as a detection of a face in a vicinity of the mobile device 100. For example, a detection of a touch operation/pattern consistent with the present disclosure in combination with a detection of a face in the vicinity of the mobile device may activate processing for lighting or extinguishing a backlight for the display 7 or turning on or off communication modes for the mobile device. For example, grip patterns P1 or P2 shown in FIG. 3 may be detected, and the controller 1 may prevent further processing from being performed until a face is detected by the image processors included in the camera 15, thereby preventing operations from being performed by the mobile device unintentionally. Images may include both still and video imagery.

Additionally, a detection of a grip pattern/touch operation in combination with a gesture performed with respect to the mobile device case may also perform additional functions, processes, etc. that were previously matched with the combination of those inputs. As a non-limiting example, a grip pattern may be detected on a mobile device in combination with a gesture of swinging down the case 101 of the mobile device 100. In response to the detected combination of inputs, an external device such as a television receiver may be controlled (e.g. turned on or off). As a further example, a grip pattern may be detected in combination with a gesture corresponding to shaking of the case 101 right and left, in which case the channels of the television receiver may be turned up or down.

Obviously, numerous modifications and variations of the present disclosure are possible in light of the above teachings. It is therefore to be understood that within the scope of the appended claims, the invention may be practiced otherwise than as specifically described herein. For example, advantageous results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable processing circuits configured to execute program code and/or computer instructions to execute the functions, processes and algorithms described herein. A processing circuit includes a programmed processor, as a processor includes circuitry. A processing circuit also includes devices such as an application specific integrated circuit (ASIC) and conventional circuit components arranged to perform the recited functions.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process. Additionally, some implementations may be performed on modules or hardware not identical to those described. Accordingly, other implementations are within the scope that may be claimed.

It must be noted that, as used in the specification and the appended claims, the singular forms “a,” “an,” and “the” include plural referents unless the context clearly dictates otherwise.

The above disclosure also encompasses the embodiments noted below.

(1) An apparatus comprising circuitry configured to: determine, as an first determination based on an output of a sensor, when an instruction object is within a predetermined distance of a surface of a display; determine, based the sensor output and the first determination result, a grip pattern corresponding to a position of one or more of a finger and a thumb on a user's hand with respect to the display surface; and execute a predetermined function or process based on the determined grip pattern.

(2) The apparatus of (1), wherein the circuitry controls the display to alter an arrangement of a displayed interface based on the determined grip pattern.

(3) The apparatus of (1) or (2), wherein the circuitry controls the display such that one or more icons included in the interface are arranged within a predetermined distance from a coordinate included in the determined grip pattern.

(4) The apparatus of any one of (1) to (3), wherein the coordinate included in the determined grip pattern corresponds to the user's thumb.

(5) The apparatus of any one of (1) to (4), wherein the circuitry controls the display such that a scrollbar included in the interface is arranged at a location on the display based on a coordinate included in the determined grip pattern.

(6) The apparatus of any one of (1) to (5), wherein the coordinate included in the determined grip pattern corresponds to the user's thumb.

(7) The apparatus of any one of (1) to (6), further comprising a case including a frame portion encompassing the display surface, wherein the circuitry determines, based on the sensor output, a coordinate corresponding to a position on the frame portion contacted by the instruction object.

(8) The apparatus of any one of (1) to (7), further comprising an audio speaker, wherein the circuitry controls a volume output from the speaker based on the determined coordinate.

(9) The apparatus of any one of (1) to (8), wherein the circuitry controls the volume based on temporal changes in coordinates included in the sensor output.

(10) The apparatus of any one of (1) to (9), wherein: the interface includes a scrollbar for scrolling content included in the interface, and the circuitry controls the display such that the scrollbar scrolls the displayed content based on the determined coordinate.

(11) The apparatus of any one of (1) to (10), wherein the circuitry controls the display such that the scrollbar scrolls the displayed content based on temporal changes in coordinates included in the sensor output.

(12) The apparatus of any one of (1) to (11), wherein: the interface includes one or more icons corresponding to the predetermined function or process, and the circuitry executes the predetermined function or process when the determined frame portion coordinate corresponds to a displayed position of the one or more icons.

(13) The apparatus of any one of (1) to (12), wherein the circuitry determines when the instruction object contacts the frame portion based on an area of the grip pattern.

(14) The apparatus of any one of (1) to (13), wherein the circuitry determines when the instruction object contacts the frame portion based on an incidence angle of the instruction object with respect to the surface of the display.

(15) The apparatus of any one of (1) to (14), wherein the circuitry determines the grip pattern based on a relative position of the user's thumb with respect to the user's fingers.

(16) The apparatus of any one of (1) to (15), wherein the circuitry is further configured to determine, based on the determined grip pattern, an area of the display that is unresponsive to input operations from instruction object.

(17) The apparatus of any one of (1) to (16), wherein the circuitry is further configured to: acquire an image of an area surrounding the apparatus; detect a presence of a facial feature in the captured image; and execute the predetermined function or process based on the detected presence of the facial feature and the determined grip pattern.

(18) The apparatus of claim 1, further comprising a communication interface configured to control one or more external devices, wherein the communication interface outputs a control signal to the one or more external devices based on the determined grip pattern.

(19) A method of executing a predetermined function or process on a mobile device including a display, the method comprising: determining, as a first determination, by circuitry based on an output of a sensor, that an instruction object is within a predetermined distance of a surface of the display; determining, by the circuitry based the sensor output and the first determination result, a grip pattern corresponding to a position of one or more of a finger and a thumb on a user's hand with respect to the display surface; and executing, by the circuitry, the predetermined function or process based on the determined grip pattern.

(20) A non-transitory computer readable medium having instructions stored therein that when executed by one or more processors causes the one or more processors to execute a method comprising: determining, as a first determination based on an output of a sensor, that an instruction object is within a predetermined distance of a surface of a display; determining, based the sensor output and the first determination result, a grip pattern corresponding to a position of one or more of a finger and a thumb on a user's hand with respect to the display surface; and executing the predetermined function or process based on the determined grip pattern.

1. An apparatus comprising:
circuitry configured to:
determine, as an first determination based on an output of a sensor, when an instruction object is within a predetermined distance of a surface of a display;
determine, based the sensor output and the first determination result, a grip pattern corresponding to a position of one or more of a finger and a thumb on a user's hand with respect to the display surface; and
execute a predetermined function or process based on the determined grip pattern.

2. The apparatus of claim 1, wherein
the circuitry controls the display to alter an arrangement of a displayed interface based on the determined grip pattern.

3. The apparatus of claim 2, wherein
the circuitry controls the display such that one or more icons included in the interface are arranged within a predetermined distance from a coordinate included in the determined grip pattern.

4. The apparatus of claim 3, wherein
the coordinate included in the determined grip pattern corresponds to the user's thumb.

5. The apparatus of claim 2, wherein
the circuitry controls the display such that a scrollbar included in the interface is arranged at a location on the display based on a coordinate included in the determined grip pattern.

6. The apparatus of claim 5, wherein
the coordinate included in the determined grip pattern corresponds to the user's thumb.

7. The apparatus of claim 1, further comprising
a case including a frame portion encompassing the display surface, wherein
the circuitry determines, based on the sensor output, a coordinate corresponding to a position on the frame portion contacted by the instruction object.

8. The apparatus of claim 7, further comprising
an audio speaker, wherein
the circuitry controls a volume output from the speaker based on the determined coordinate.

9. The apparatus of claim 8, wherein
the circuitry controls the volume based on temporal changes in coordinates included in the sensor output.

10. The apparatus of claim 7, wherein:
the interface includes a scrollbar for scrolling content included in the interface, and
the circuitry controls the display such that the scrollbar scrolls the displayed content based on the determined coordinate.

11. The apparatus of claim 10, wherein
the circuitry controls the display such that the scrollbar scrolls the displayed content based on temporal changes in coordinates included in the sensor output.

12. The apparatus of claim 7, wherein:
the interface includes one or more icons corresponding to the predetermined function or process, and
the circuitry executes the predetermined function or process when the determined frame portion coordinate corresponds to a displayed position of the one or more icons.

13. The apparatus of claim 7, wherein
the circuitry determines when the instruction object contacts the frame portion based on an area of the grip pattern.

14. The apparatus of claim 7, wherein
the circuitry determines when the instruction object contacts the frame portion based on an incidence angle of the instruction object with respect to the surface of the display.

15. The apparatus of claim 1, wherein
the circuitry determines the grip pattern based on a relative position of the user's thumb with respect to the user's fingers.

16. The apparatus of claim 1, wherein the circuitry is further configured to
determine, based on the determined grip pattern, an area of the display that is unresponsive to input operations from instruction object.

17. The apparatus of claim 1, wherein the circuitry is further configured to:
acquire an image of an area surrounding the apparatus;
detect a presence of a facial feature in the captured image; and
execute the predetermined function or process based on the detected presence of the facial feature and the determined grip pattern.

18. The apparatus of claim 1, further comprising
a communication interface configured to control one or more external devices, wherein
the communication interface outputs a control signal to the one or more external devices based on the determined grip pattern.

19. A method of executing a predetermined function or process on a mobile device including a display, the method comprising:
determining, as a first determination, by circuitry based on an output of a sensor, that an instruction object is within a predetermined distance of a surface of the display;
determining, by the circuitry based the sensor output and the first determination result, a grip pattern corresponding to a position of one or more of a finger and a thumb on a user's hand with respect to the display surface; and
executing, by the circuitry, the predetermined function or process based on the determined grip pattern.

20. A non-transitory computer readable medium having instructions stored therein that when executed by one or more processors causes the one or more processors to execute a method comprising:
determining, as a first determination based on an output of a sensor, that an instruction object is within a predetermined distance of a surface of a display;
determining, based the sensor output and the first determination result, a grip pattern corresponding to a position of one or more of a finger and a thumb on a user's hand with respect to the display surface; and
executing the predetermined function or process based on the determined grip pattern.
